(19) United States
(12) Patent Application Publication
(10) Pub. No.: US 2010/0287262 A1
(43) Pub. Date: Nov. 11, 2010

(54) METHOD AND SYSTEM FOR GUARANTEED END-TO-END DATA FLOWS IN A LOCAL NETWORKING DOMAIN

(76) Inventor: Uri Elzur, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/775,589

(22) Filed: May 7, 2010

Related U.S. Application Data
(60) Provisional application No. 61/176,621, filed on May 8, 2009.

(51) Int. Cl. G06F 15/177

(52) U.S. Cl. 709/220; 709/232

(57) ABSTRACT

A local manager in a local networking domain may configure, in conjunction with one or more switching devices, a plurality of network and/or switching devices to establish guaranteed end-to-end data flows in the local networking domain for servicing applications and/or processes running in the network devices. The network devices supporting or using guaranteed end-to-end data flows may determine data flow requirements for each serviced application, and may communicate the determined data flow requirements to switching devices supporting the local manager, for configuring the guaranteed end-to-end data flows. Data flow requirements may comprise bandwidth, quality of service (QoS), security, and/or service level agreement (SLA) related parameters. The network devices may allocate networking resources to guarantee the end-to-end data flow for each application running in each network device. Data flow routing tables maybe maintained and/or updated based on use of existing guaranteed end-to-end data flows.

### CROSS-REFERENCE TO RELATED APPLICATIONS/INCORPORATION BY REFERENCE

This patent application makes reference to, claims priority to and claims benefit from U.S. Provisional Application Ser. No. 61/176,621 which was filed on May 8, 2009.

The above referenced application is hereby incorporated herein by reference in its entirety

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to networking. More specifically, certain embodiments of the invention relate to a method and system for guaranteed end-to-end data flows in a local networking domain.

### BACKGROUND OF THE INVENTION

An electronic communication network is a collection of two or more computing nodes, which are communicatively coupled via a transmission medium and utilized for transmitting information. Most networks adhere to the layered approach provided by the open systems interconnect (OSI) reference model. The OSI reference provides a seven (7) layer approach, which includes an application layer, (Layer 7), a presentation layer (layer 6), a session layer (Layer 5), a transport layer (Layer 4), a network layer (Layer 3), a data link layer (Layer 2) and a physical layer (Layer 1). Layer 7 through layer 5 inclusive may comprise upper layer protocols, while layer 4 through layer 1 may comprise lower layer protocols. Some networks may utilize only a subset of the 7 OSI layers. For example, the TCP/IP model, or Internet Reference model generally utilizes a 5 layer model, which comprises an application layer, (Layer 7), a transport layer (Layer 4), a network layer (Layer 3), a data link layer (Layer 2) and a physical layer (Layer 1). These five layers can be broken down into a fairly specific set of responsibilities or services, which they provide.

As electronic communication networks become increasingly popular, ways of exchanging data of various types, sizes for a variety of applications and business and consumers alike want faster and faster network access on more and more devices. Furthermore, malicious traffic and/or other security threats also increase with the increased reliance on electronic information. Consequently, communicating the ever increasing amounts of data and number of devices in a network presents many challenges to network and system designers and administrators.

Virtualization is one area that system designers and administrators have looked to for improving networks. In this regard, in non-virtualized systems, a single machine, for example, a server or a client, may be utilized to concurrently support multiple server operations or services. For example, a single server may be utilized for providing access to business applications while also operating as an email server, a database server, and/or an exchange server. The server may generally support the various server operations by utilizing a single operating system (OS). The server operations, via the single OS, make use of server processing resources such as the central processing unit (CPU), memory, network interface card (NIC), peripheral sound card, and/or graphics card, for example. In many instances, the server resources may not be efficiently utilized because the demand for server operations generally vary based on the type of service provided and/or user needs. Consolidating server services into a single physical machine may result in an improvement in server efficiency. However, consolidation also removes the level of protection that is provided when the operations are maintained separately. For example, when the operations are consolidated, a crash or failure in a database server may also result in the loss of email services, exchange services, and/or application services.

Virtualization, however, may improve server efficiency. Virtualization may comprise utilizing multiple operating systems running concurrently on the server so that each operating system supports a different server operation or application or service, for example. The multiple operating systems may be referred to as guest operating systems (GOSs) or child partitions. This approach maintains the level of protection provided when server operations are not consolidated under a single operating system while also enabling the optimization of the usage of the processing resources available to the server. The use of multiple guest operating systems may be referred to as OS virtualization because each GOS perceives to have full access to the server's hardware resources. In this regard, a GOS is unaware of the presence of any other GOS running on the server. In order to implement OS virtualization, a software layer may be utilized to arbitrate access to the server's hardware resources. This software layer may be referred to as a hypervisor or virtual machine (VM) monitor, for example. The hypervisor may enable the multiple GOSs to access the hardware resources in a time-sharing manner. This software layer may be assisted by a trusted GOS (TGOS), which may also be referred to as a parent partition, or Virtual Machine Kernel (VMK) for instance. Although virtualization is useful in many contexts, it does not address many of the challenges faced by system designers and network administrators, and in-fact, presents many new challenges.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for guaranteed end-to-end data flows in a local networking domain, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary local networking domain comprising network devices and switching devices, which may be utilized in accordance with an embodiment of the invention.

FIG. 2A is a block diagram illustrating an exemplary network device, which may support use of guaranteed end-to-end data flows in a local networking domain, in accordance with an embodiment of the invention.

FIG. 2B is a block diagram illustrating an exemplary switching device, which may support use of guaranteed end-to-end data flows in a local networking domain, in accordance with an embodiment of the invention.

FIG. 3A is a block diagram illustrating an exemplary architecture for a network device that supports end-to-end data flows by multiple applications running in a single OS, in accordance with an embodiment of the invention.

FIG. 3B is a block diagram illustrating an exemplary architecture for a network device that supports use of end-to-end data flows by multiple applications running in a plurality of virtual machines, in accordance with an embodiment of the invention.

FIG. 4A is a block diagram illustrating an exemplary local networking domain that utilizes end-to-end data flows between network devices via switching devices in the local networking domain, in accordance with an embodiment of the invention.

FIG. 4B is a block diagram that illustrates an exemplary end-to-end routing table that may be utilized in a local networking domain to support guaranteed end-to-end data flows, in accordance with an embodiment of the invention.

FIG. 5 is a flow chart that illustrates exemplary steps for configuring and maintaining guaranteed end-to-end data flows in a local networking domain, in accordance with an embodiment of the invention.

### DETAILED DESCRIPTION OF THE INVENTION

Certain embodiments of the invention may be found in a method and system for guaranteed end-to-end data flows in a local networking domain. In various embodiments of the invention, in a local networking domain comprising a plurality of network devices and one or more switching devices, a local manager in the local networking domain may configure one or more of the plurality of network devices and/or one or more of the switching devices to establish end-to-end data flows with guaranteed communication related properties and/or parameters. In this regard, each of the plurality of network devices may utilize the guaranteed end-to-end data flows to service applications that may be running on the network devices. One or more of the network devices may be operable to determine data flow requirements for each of the applications. The determined data flow requirements may be communicated to one or more switching devices which may, in conjunction with the local manager, support, configure, and/or manage use of guaranteed end-to-end data flows in the local networking domain. Based on the determined data flow requirements, the network devices may allocate networking resources to guarantee the end-to-end data flow for each application running in each of the plurality of network devices. The guaranteed end-to-end data flows may be used for communicating data and/or messages that transmitted and/or received by applications and/or processes running in the network devices. The data flow requirements may comprise bandwidth, quality of service (QoS), security, and/or service level agreement (SLA) related parameters. Exemplary switching devices may comprise blade switches and/or top-of-rack (ToR) switches. The local manager may be implemented and/or run in, at least in part, the one or more switching devices. Data flow routing tables maybe maintained and/or updated based on usage of the existing guaranteed end-to-end data flows.

The local manager and/or the switching devices may maintain a routing table for storing information corresponding to each guaranteed end-to-end data flow in the local networking domain. To facilitate maintenance of routing information, each of the end-to-end data flows may be assigned a unique identifier for routing and/or switching operations in the local networking domain. Each end-to-end data flow may also be assigned a unique virtual local area network (VLAN) tag, which may be used for filtering data corresponding to the end-to-end data flow in each serviced network device. One or more of the network devices that are serviced by the guaranteed end-to-end data flows may be virtualized. Furthermore, in instances where the one or more of the network devices are implemented as virtual platforms, guaranteed end-to-end data flow servicing may be maintained and/or continued when serviced applications, and/or virtual machines in which the application may be run or executed, may be migrated between physical devices.

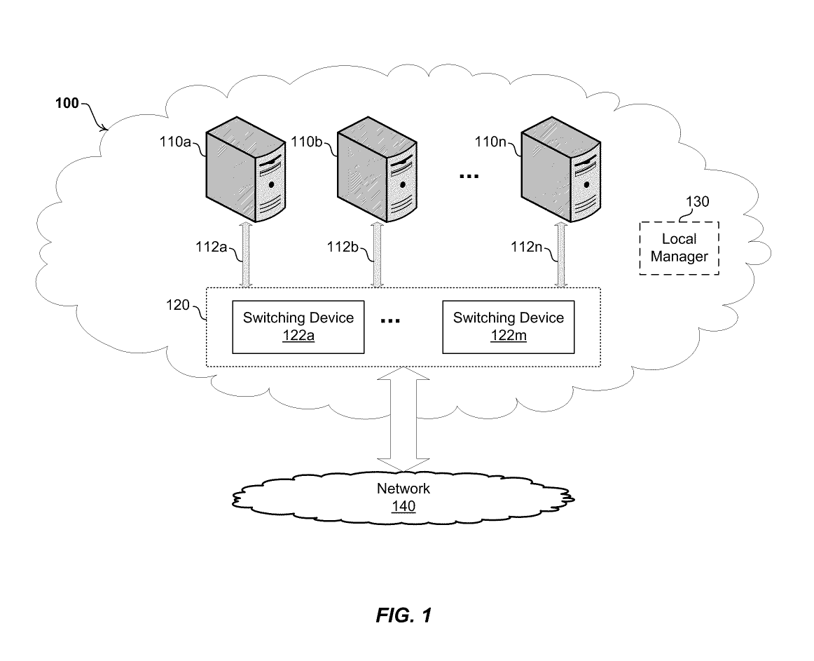

FIG. 1 is a block diagram illustrating an exemplary local networking domain comprising network devices and switching devices, which may be utilized in accordance with an embodiment of the invention. Referring to FIG. 1, there is shown a local networking domain 100 comprising a plurality of network devices 110a, 110b, . . . , 110n, a switching system 120, comprising a plurality of switching devices 122a-122m, and a local manager 130. Also shown in FIG. 1 is an external network 140.

The local networking domain 100 may comprise plurality of devices and/or entities, which may be inter-connected, directly and/or via other devices and/or entities within the local networking domain 100, and/or may be administered and/or managed by a single entity, such as the local manager 130. In this regard, the local networking domain 100 may comprise the plurality of network devices 110a-110m, and the switching system 120. The switching system 120 may comprise the plurality of switching devices 122a-122m, and the local manager 130. The network devices 110a-110m may be operable to transmit and/or receive data and/or messages external to the local networking domain 100, to and/or from other devices and/or entities accessed via the network 140 for example, via the switching system 120. In an exemplary aspect of the invention, the network devices 110a, 110b, . . . , 110n may also support internal communication, within the local networking domain 100, via the switching system 120, wherein each of the network devices 110a, 110b, . . . , 110n may transmit data to and/or receive data from other network devices using connections which may also may by utilized during external communications.

Each of the network devices 110a, 110b, . . . , 110n may comprise suitable logic, circuitry, interfaces, and/or code that may be operable to perform various tasks and/or execute applications based on, for example, preloaded instructions and/or user input. Exemplary network devices may comprise a server, a personal computer (PC), a laptop, a smart phone, and/or handheld mobile device. Each of the network devices 110a, 110b, . . . , 110n may communicate data and/or messages during performance of tasks and/or execution of applications. In this regard, the network devices 110a, 110b, . . . , 110n may transmit and/or receive data via the switching system 120. The network devices 110a, 110b, . . . , 110n may utilize network links 112a, 112b, . . . , 112n, respectively, for communicating with the switching system 120. In this regard, each of the network links 112a, 112b, . . . , 112n may comprise an Ethernet link, such as 10 Gigabit Ethernet (10 GbE) link. In an exemplary aspect of the invention, the switching system 120 may enable transmitting and/or receiving data internally within the local networking domain 100, among the network devices 110a, 110b, . . . , 110n. In an exemplary aspect of the invention, the network devices 110a, 110b, . . . , 110n may be operable to communicate data and/or messages within the local networking domain 100, via the switching system 120 for example. Furthermore, applications running in each of the network devices 110a, 110b, . . . , 110n may share the network links 112a, 112b, . . . , 112n for communication. Accordingly, during inter-device communication within the local networking domain, at least some of the network links 112a, 112b, . . . , 112n may be utilized for communicating data and/or messages between the network devices 110a, 110b, . . . , 110n, via the switching system 120 for example. In this regard, the communicated data may correspond to data communicated by the serviced data, and the communicated messages may correspond to messaging exchanged by the network devices, and/or any entities therein that execute and/or run the applications, to facilitate the data exchange between the services applications.

The switching system 120 may comprise suitable logic, circuitry, interfaces, and/or code for performing switching and routing of information within the local networking domain 100. The switching system 120 may comprise the plurality of switching devices 122a-122m. The switching devices 122a-122m may comprise, for example, blade switches, top-of-rack (ToR) switches, and/or any combinations thereof. In this regard, the switching system 100 may provide external routing of data communicated by the network devices 110a, 110b, . . . , 110n, to and/or from the external network 140 for example. Switching operations may be performed by one or more networking layers based on, for example, the Open Systems Interconnection (OSI) Model. For example, the switching system 120 may be operable to perform L2, L3, L4, VLAN, and/or any other higher and/or additional protocol layer based switching. In an exemplary aspect of the invention, the switching system 120 may also provide internal routing within the local networking domain 100, to enable and/or support data and/or messages communication internally within the local networking domain 100, among the network devices 110a, 110b, . . . , 110n for example.

The local manager 130 may comprise suitable logic, circuitry, interfaces, and/or code that may operable to manage and/or control operations of the local networking domain 100. In this regard, the local manager 130 may configure, control, and/or manage, for example, internal data communication in the local networking domain 100, among the network devices 110a, 110b, . . . , 110n. While the local manager 130 is shown as a separate component within the local networking domain 100, the invention need not be so limited. For example, the functionality and/or operations described herein with regard to the local manager 130 may be performed by other components of the system 300, such as one or more of the switching devices 122a-122m for example.

The network 140 may comprise a system of interconnected networks and/or devices which may enable exchange of data and/or messages among a plurality of nodes, based on one or more networking standards, including, for example, Internet Protocols (IP). The network 140 may comprise a plurality of broadband capable subnetworks, which may comprise, for example, satellite networks, cable networks, DVB networks, the Internet, and/or other local or wide area network. These subnetworks may collectively enable conveying data, via Ethernet packets for example, to plurality of end users. In this regard, physical connectivity within, and/or to or from the network 140, may be provided via copper wires, fiber-optic cables, wireless interfaces, and/or other standards-based interfaces. The network devices 110a, 110b, . . . , 110n may obtain external networking connectivity by accessing the network 140, via the switching system 120, for example.

In operation, the local networking domain 100 may provide guaranteed end-to-end data flow servicing to support applications and/or processes running and/or executing in the network devices 110a, 110b, . . . , 110n. In this regard, end-to-end data flows may refer to data and/or messages exchanged between components and/or entities, such as applications for example, which may reside and/or run on different network devices in the local networking domain 100. Guaranteeing end-to-end data flows may comprise ensuring minimal properties for providing data communication. In this regard, exemplary data communication properties may comprise parameters and/or information pertaining to and/or defining allocated bandwidths, quality of service (QoS), service level agreements, security, and/or any combinations thereof. Accordingly, supporting guaranteed end-to-end data flow servicing enables the network devices 110a, 110b, . . . , 110n to provide a guaranteed “contract” that ensures each of the serviced applications running on those devices that any data and/or messages communication performed during the execution of the application would maintain at least the minimum communication properties guaranteed, regardless of other operations performed and/or changes in conditions in the local networking domain 100 for example.

In various embodiments of the invention, Data Center Bridging (DCB) may be utilized to guarantee various service levels for each of the end-to-end data flows. In this regard, because DCB is a hop-by-hop protocol, which uses Link Layer Discovery Protocol (LLDP), end-to-end flow servicing in the local networking domain 100, via the local manager 130 for example, may incorporate and/or be coordinated using DCB on per-hop basis, that is, between each two consecutive devices in the end-to-end flow path.

In an exemplary embodiment of the invention, the end-to-end data flow servicing may have dynamic capability. In this regard, the guaranteed properties of end-to-end data flows may be adjusted and/or modified, based on, for example, user input and/or change of conditions in the local networking domain 100. Furthermore, the end-to-end data flows may be maintained, and data flow servicing may continue consistently and/or seamlessly even where one or more of the edges of the end-to-end data flow are moved within the local networking domain, such as, for example, when virtualization techniques are used to enable migration of applications and/or operating systems for example. In this regard, one or more of applications interacting via the end-to-end data flows may be moved from one network device to another in the local networking domain without any disturbance to and/or change in the properties of the end-to-end data flow. In some instances, such moves may also be coordinated with one or more external events, such as, for example, virtualization based migrations. For example, in instances where at least some of the network devices are implemented as virtual platforms, wherein the serviced applications may be run and/or be executed in virtual machines (VMs) for example, end-to-end data flow servicing of the application may continue seamlessly during migration of the VMs, and/or serviced applications running therein, from one physical network device to another. Furthermore, in some embodiments of the invention, pre-inspection services may be run, via the local manager 130 for example, to determine whether devices and/or entities along the path of the new end-to-end data flow may support the original guaranteed servicing contract. Exemplary services that may be provided may include support during and after migration, including exact and timely control of access control lists (ACLs).

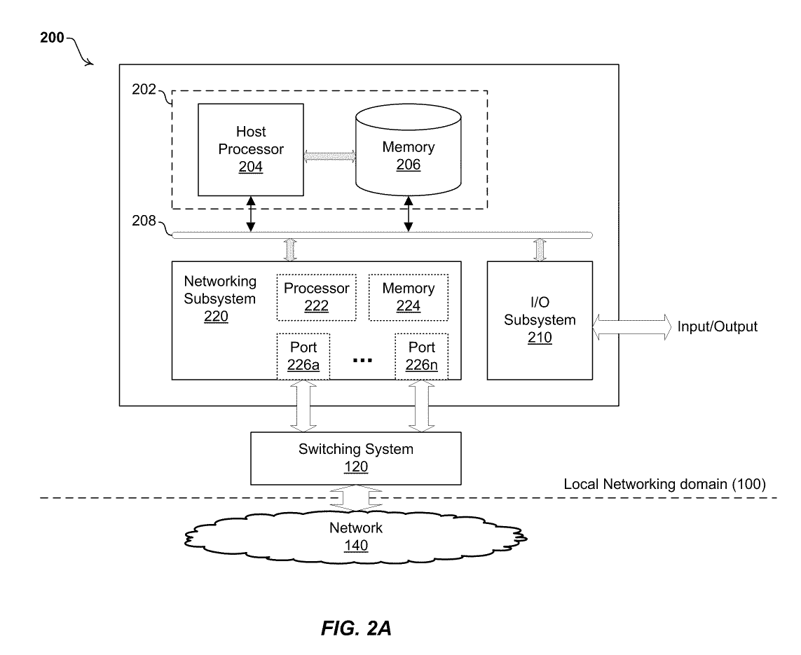

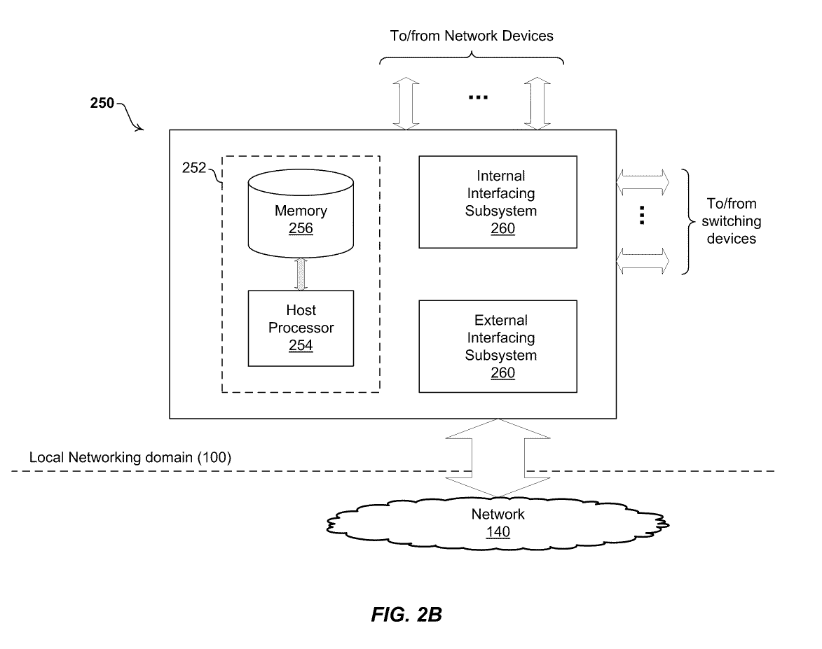

FIG. 2A is a block diagram illustrating an exemplary network device which may support use of guaranteed end-to-end data flows in a local networking domain, in accordance with an embodiment of the invention. Referring to FIG. 2A, there is shown a network device 200, a host subsystem 202, a system bus 208, an input/output (I/O) subsystem 210, and a networking subsystem 220. Also shown in FIG. 2A is the switching system 120 and network 140 of FIG. 1.

The network device 200 may correspond to one or more of the network devices 110a, 110b, . . . , 110n, substantially as described with regard to FIG. 1. The network device 200 may comprise the host subsystem 202, the system bus 208, the I/O subsystem 210, and/or the networking subsystem 220. In this regard, the host subsystem 202 may provide control and/or management of the operations of the network device 200. The I/O subsystem 210 may enable user interactions with the network device 200. The networking subsystem 220 may enable communication of data and/or messages from and/or to the network device 200, when executing various tasks and/or applications. The network device 200 may also comprise other hardware resources (not shown) such as a graphics card and/or a peripheral sound card, for example.

The host subsystem 202 may comprise suitable logic, circuitry, interfaces, and/or code that may be operable to control and/or manage operations of the network device 200, and/or tasks and/or applications performed therein. The host subsystem may comprise, for example, a host processor 204 and/or a host memory 206. The host processor 204 may comprise suitable logic, circuitry, interfaces and/or code that may be operable to process data and/or control operations of the network device 200. In this regard, the host processor 204 may be operable to configure and/or control operations of various components and/or subsystems of the network device 200, by utilizing, for example, one or more control signals. The host processor 204 may also control data transfers within the network device 200. The host processor 204 may enable execution of applications, programs and/or code, which may be stored in the host memory 206 for example. The host memory 206 may comprise suitable logic, circuitry, interfaces and/or code that enable permanent and/or non-permanent storage and/or fetching of data, code and/or other information used in the network device 200. In this regard, the host memory 206 may comprise different memory technologies, including, for example, read-only memory (ROM), random access memory (RAM), and/or Flash memory. The host memory 206 may store, for example, configuration data, which may comprise parameters and/or code, comprising software and/or firmware, but the configuration data need not be limited in this regard.

The system bus 208 may comprise suitable logic, circuitry, interfaces, and/or code that may enable exchange of data and/or messages between various components and/or systems in the system 300. In this regard, the system bus may comprise parallel or serial, and/or internal or external based bus technologies, and/or any combinations thereof. Exemplary system bus interfaces may comprise Inter-Integrated Circuit (I²C), Universal Serial Bus (USB), Advanced Technology Attachment (ATA), Small Computer System Interface (SCSI), Peripheral Component Interconnect (PCI), and/or Peripheral Component Interconnect Express (PCI-e) based interfaces.

The I/O subsystem 210 may comprise suitable logic, circuitry, interfaces, and/or code that may enable input and/or outputting data and/or messages. In this regard, I/O subsystem 210 may support user interactions with the network device 200, to receive user input and/or provide user output.

The networking subsystem 220 may comprise suitable logic, circuitry, interfaces, and/or code that may be operable to communicate data and/or messages from and/or to the network device 200. The networking subsystem 220 may comprise, for example, a network interface controller or chip (NIC). The networking subsystem 220 may comprise, for example, the networking processor 222, the networking memory 224, and/or the plurality of ports 226a-226n. The networking processor 222 may comprise suitable logic, circuitry, interfaces, and/or code for controlling and/or managing operations of the networking subsystem 220. The networking memory 224 may comprise suitable logic, circuitry, and/or code for dedicated storage and/or buffering of data in the networking subsystem 220. In this regard, the networking memory 224 may comprise one or more ROM and/or RAM memory devices. Each of the plurality of ports 226a-226n may comprise suitable logic, circuitry, interfaces, and/or code for providing network interfacing functionality, in the networking subsystem 220, based on one or more networking standards and/or protocols. The plurality of ports 226a-226n may comprise, for example, 10 Gigabit Ethernet ports. In this regard, the plurality of ports 226a-226n may enable sharing of network links used by the network device 200 local networking domain among applications and/or processes running in the network device 200. For example, the network links 112a, 112b, . . . , 112n in the local networking domain 100 may be shared among the plurality of ports 226a-226n.

The networking subsystem 220 may support and/or perform, for example, physical (PHY) layer related access, via the plurality of ports 226a-226n, and/or processing therefor. The networking subsystem 220 may also perform at least some switching, such as layer 2 (L2) based switching for example, during transmission and/or reception of data packets. The switching supported by the networking subsystem 220, however, need not be limited to L2, and may comprise L2, L3, L4, VLAN, and/or other protocol layer.

In operation, the network device 200 may be integrated into a local networking domain, such as the local networking domain 100 of FIG. 1 for example. In this regard, the network device may transmit and/or receive data and/or messages, via the networking subsystem 210 for example. For example, data and/or messages communicated by the network device 200 may be transmitted and/or received via a network link, corresponding to one of the network links 112a, 112b, . . . , 112n for example, via the plurality of ports 226a-226n. In addition, data and/or messages sent by and/or to the network device 200 may be routed and/or switched via the switching system 120 of the local networking domain 100, using one or more of the switching devices 122a-122m for example. The network device 200 may support execution of a plurality of applications and/or processes, via the host subsystem 202, for example. Furthermore, one or more of the applications and/or processes executed by the network device 200 may require user input and/or output, which may be received and/or provided via the I/O subsystem 210, for example.

In an exemplary aspect of the invention, the execution of one or more of the applications and/or processes by the network device 200 may necessitate transmitting and/or receiving of data and/or messages to and/or from other network devices in the local networking domain 100. Accordingly, the network device 200 may utilize guaranteed end-to-end data flows to support these applications and/or processes running in the network device 200. In this regard, the network device 200 may determine properties and/or parameters of data communication, such as bandwidth, quality of service (QoS), service level agreement(s), security, and/or any combinations thereof, which may be necessary for running and/or executing applications and/or processes in the network device 200. Accordingly, the network device 200 may provide guaranteed “contracts” ensuring that the applications and/or processes running and/or executing in the network device 200 may be ensured consistent and/or sufficient end-to-end data flows in the local networking domain 100. In this regard, the network device 200 may communicate the determined data communication properties and/or parameters to a central entity in the local networking domain 100, such as the local manager 130, which may use that information in establishing, configuring, and/or managing end-to-end data flow servicing, by configuring, for example, other devices and/or components which may be traversed in the data flow path to ensure satisfying these determined data communication properties.

FIG. 2B is a block diagram illustrating an exemplary switching device which may support use of guaranteed end-to-end data flows in a local networking domain, in accordance with an embodiment of the invention. Referring to FIG. 2B, there is shown a switching device 250, a host subsystem 252, an internal interfacing subsystem 260, and an external interfacing subsystem 270. Also shown in FIG. 2A is the network 140 of FIG. 1.

The switching device 250 may correspond to one or more of the switching devices 122a-122n, substantially as described with regard to FIG. 1. The switching device 250 may comprise the host subsystem 252, the internal interfacing subsystem 260, and/or the external interfacing subsystem 270. In this regard, the host subsystem 252 may provide control and/or management of the operations of the switching device 250. The internal interfacing subsystem 260 may enable communication of data and/or messages between the switching device 250 and network devices and/or other switching devices in a local networking domain in which the switching device 250 may be integrated. The external interfacing subsystem 260 may enable communication of data and/or messages via the switching device 250 external to a local networking domain in which the switching device 250 may be integrated. The switching device 250 may also comprise other hardware resources (not shown) such as a graphics card and/or a peripheral sound card, for example.

The host subsystem 252 may comprise suitable logic, circuitry, interfaces, and/or code that may be operable to control and/or manage operations of the switching device 250, and/or tasks and/or applications performed therein. The host subsystem may comprise, for example, a host processor 254 and/or a host memory 256. The host processor 254 may comprise suitable logic, circuitry, interfaces and/or code that may be operable to process data and/or control operations of the switching device 250. In this regard, the host processor 254 may be operable to configure and/or control operations of various components and/or subsystems of the switching device 250, by utilizing, for example, one or more control signals. The host processor 254 may also control data transfers within the switching device 250. The host processor 254 may enable execution of applications, programs and/or code, which may be stored in the host memory 256 for example. The host memory 256 may comprise suitable logic, circuitry, interfaces and/or code that enable permanent and/or non-permanent storage and/or fetching of data, code and/or other information used in the switching device 250. In this regard, the host memory 256 may comprise different memory technologies, including, for example, read-only memory (ROM), random access memory (RAM), and/or Flash memory. The host memory 256 may store, for example, configuration data, which may comprise parameters and/or code, comprising software and/or firmware, but the configuration data need not be limited in this regard.

The internal interfacing subsystem 260 may comprise suitable logic, circuitry, interfaces, and/or code that may be operable to receive and/or transmit data and/or messages between the switching device 250 and network devices and/or other switching devices in a local networking domain in which the switching device 250 may be integrated.

The internal interfacing subsystem 260 may comprise suitable logic, circuitry, interfaces, and/or code that may be operable to receive and/or transmit data and/or messages via the switching device 250 external to a local networking domain in which the switching device 250 may be integrated.

In operation, the switching device 250 may be integrated into a local networking domain, such as the local networking domain 100 of FIG. 1 for example, as one or the switching devices 122a-122m in the switching system 120. In this regard, the switching device 250 may provide internal and/or external switching and routing of data and/or messages in the local networking domain 100 of FIG. 1. For example, the switching device 250 may perform, for example, physical (PHY) layer processing, via the plurality of internal and/or external ports, and/or higher layer based switching operations. The switching supported by the switching device 250 comprise L2, L3, L4, VLAN, and/or any other higher and/or additional protocol layer based switching, and/or any combinations thereof. Accordingly, the switching device 250 may utilize L2 (e.g. MAC based) and/or VLAN based switching during internal routing of data within the local networking domain 100, for example.

In an exemplary aspect of the invention, the switching device 250 may, independently and/or in conjunction with other similar switching devices in the local networking domain 100, implement the local manager local manager 130, and/or perform any operations and/or functionality thereof. In this regard, various processing, storage, control, and/or management operations and/or tasks that are described with regard to the local manager 130 may be performed, for example, by the host subsystem 252. Accordingly, in various embodiments of the invention, the switching device 250 may provide service that guarantees various propertied to the end-to-end data flows in the local networking domain 100. In this regard, the switching device 250 may configure, maintain, and/or manage end-to-end data flows, among the network devices 100a-100n. Management and/or control operations may be performed via the host subsystem 252 in the switching device 250, for example, during end-to-end data flow based operations in the local networking domain 100. In an exemplary embodiment of the invention, the switching device 250 may maintain and/or utilize data flow profiles which may utilize DCB to configure, monitor, and/or manage each hop to guarantee various properties for the end-to-end data flows.

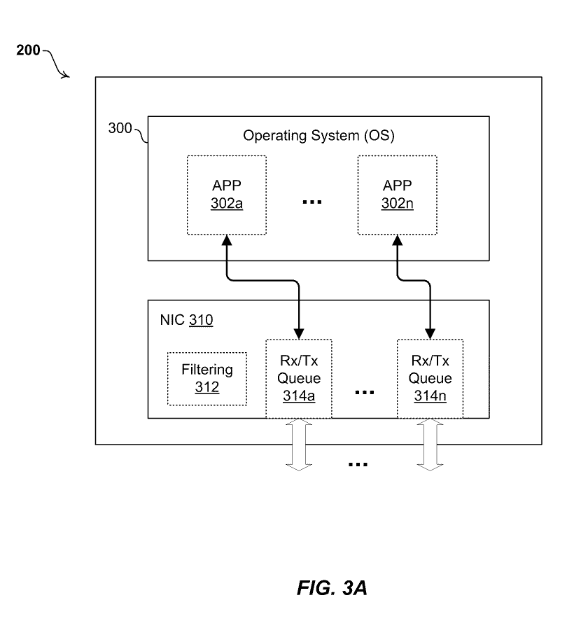

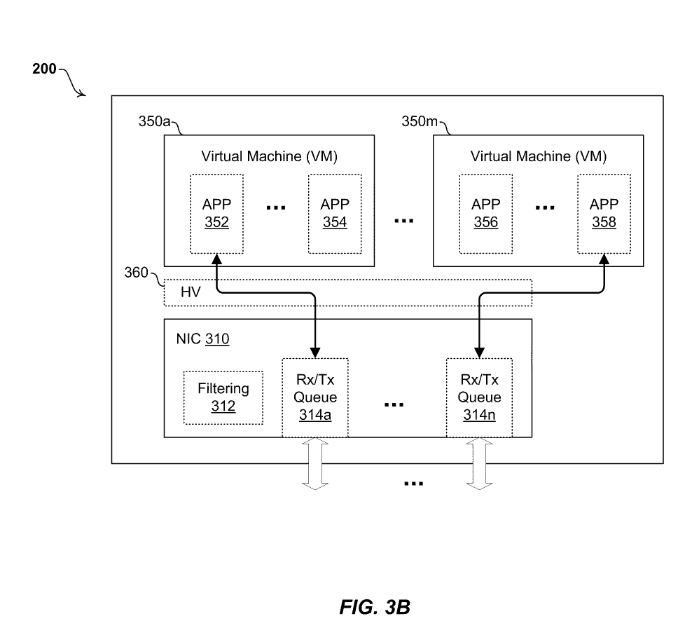

FIG. 3A is a block diagram illustrating an exemplary architecture for a network device supporting use of end-to-end data flows by multiple applications running in a single OS, in accordance with an embodiment of the invention. Referring to FIG. 3A, there is shown network device 200 of FIG. 2A. Also shown in FIG. 3A is an operating system (OS) 300, and a network interface controller (NIC) 310, which may correspond to the networking subsystem 220 of FIG. 2A.

The operating system (OS) 300 may comprise software or code that may execute programs and/or applications that are executed by a processor. In this regard, the OS 300 may be run via the host subsystem 202 of the network device 200. The OS 300 may comprise a proprietary or open-source operating systems, and may comprise various components that may support specific applications and/or may enable interacting with specific types of hardware resources, such as network interface controllers (NICs). The OS 300 may be operable to execute various operations or services, in the network device 100, such as, for example, software applications, email server operations, database server operations, and/or exchange server operations, for example, which may be represented as a plurality of applications 302a-302n.

The NIC 310 may comprise suitable logic, circuitry, interfaces, and/or code which may be operable to provide network access and/or data communication, substantially as described with regard to the networking subsystem 220 in, for example, FIG. 2A. In an exemplary aspect of the invention, the NIC 310 may provide various functions, which may be implemented using the processor 222, the memory 224, and/or one or more of the ports 226a-226n. In this regard, the NIC 310 may comprise a filtering block 312 and a plurality of transmit and/or receive (Tx/Rx) queues 314a-314n. Each of the plurality Tx/Rx queues 314a-314n may be operable to buffer and/or forward data and/or packets transmitted and/or received by applications running the network device 200. In this regard, each of the Tx/Rx queues 314a-314n may be assigned to a specific application, which may be running in the OS 300 for example. For example, the filtering block 312 may be operable to filter data received via the NIC 310, to determine to which Tx/Rx queue the data may be forwarded for example. In this regard, the filtering block 312 may filter data based on, for example, Media Access Control (MAC) and/or virtual local area network (VLAN) tags and/or parameters in the received data packets.

In an exemplary aspect of the invention, the OS 300 may be operable to support, in conjunction with the NIC 310, use of guaranteed end-to-end data flows for servicing one or more of the plurality of applications 302a-302n, substantially as described with regard to, for example, FIG. 1.

FIG. 3B is a block diagram illustrating an exemplary architecture for a network device supporting use of end-to-end data flows by multiple applications running in a plurality of virtual machines, in accordance with an embodiment of the invention. Referring to FIG. 3B, there is shown the network device 200, and the network interface controller (NIC) 310. Also shown in FIG. 3B is a plurality of virtual machines (VMs) 350a-350m, and hypervisor 360.

Each of the virtual machines (VMs) 350a-350m may comprise a software implementation that may execute and/or perform programs and/or applications that are typically executed and/or performed by physical machines, such as a computer. In this regard, the OS 300 may be run as part of the host subsystem 202 of the network device 200. Each of the VMs 350a-350m may generally function as separate operating system (OS), such as the OS 300 for example. Accordingly, each of the VMs 350a-350m may enable running and/or execution of various operations or services, in the network device 100, which may be represented as a plurality of applications 352-358. In this regard, the plurality of applications 352-358 may correspond to, for example, software applications, email server operations, database server operations, and/or exchange server operations.

The hypervisor (HV) 360 may comprise suitable logic, code, interfaces, and/or circuitry that may be utilized in a virtualized environment to support, for example, multiple virtual machines (VMs) that may run concurrently on a single platform. In this regard, the hypervisor 360 may correspond to physical and/or virtual components of the host subsystem 202, and/or other entities and/or subsystems within the network device 200. The hypervisor 360 may operate as a software layer that may run directly on top of hardware resources, such as the NIC 310, to enable virtualization of the hardware and/or physical resources of the network device 200.

Each of the virtual machines (VMs) 350a-350m may be operable to support and/or handle interactions with the NIC 310, with or without the assistance of the hypervisor 360, to facilitate communication of data and/or messages during execution and/or running of the applications 352-358. In some embodiments of the invention, the hypervisor 360 and/or the NIC 310 may also support virtual switching to further enhance virtualization of the network device 200. For example the hypervisor 360 may comprise a vSwitch component, and/or the NIC 310 may support use of eSwitch, VEB, VEPA, and/or VNtag based switching.

The number of VMs that may be supported by the host subsystem 202 need not be limited to any specific number. In this regard, the number of VMs that may run in the network device 200 may depend on, for example, configuration data and/or resources availability. For example, operations and/or use of the host processor 204 may be partitioned utilizing, for example, time division multiplexing to support each VM. Moreover, the hypervisor 360 may have a corresponding timeslot for each VM. Similarly, the host memory 206 may be partitioned into a plurality of logical memory portions, to enable supporting each of existing VMs. In this regard, each VM supported by the host subsystem 202 may have a corresponding memory portion in the host memory 206. Moreover, the hypervisor 360 may also have a corresponding memory portion in the host memory 206.

In an exemplary aspect of the invention, the VMs 350a-350m may be operable to support, in conjunction with the NIC 310, use of guaranteed end-to-end data flows, for servicing one or more of the plurality of applications 352-358, substantially as described with regard to, for example, FIG. 1.

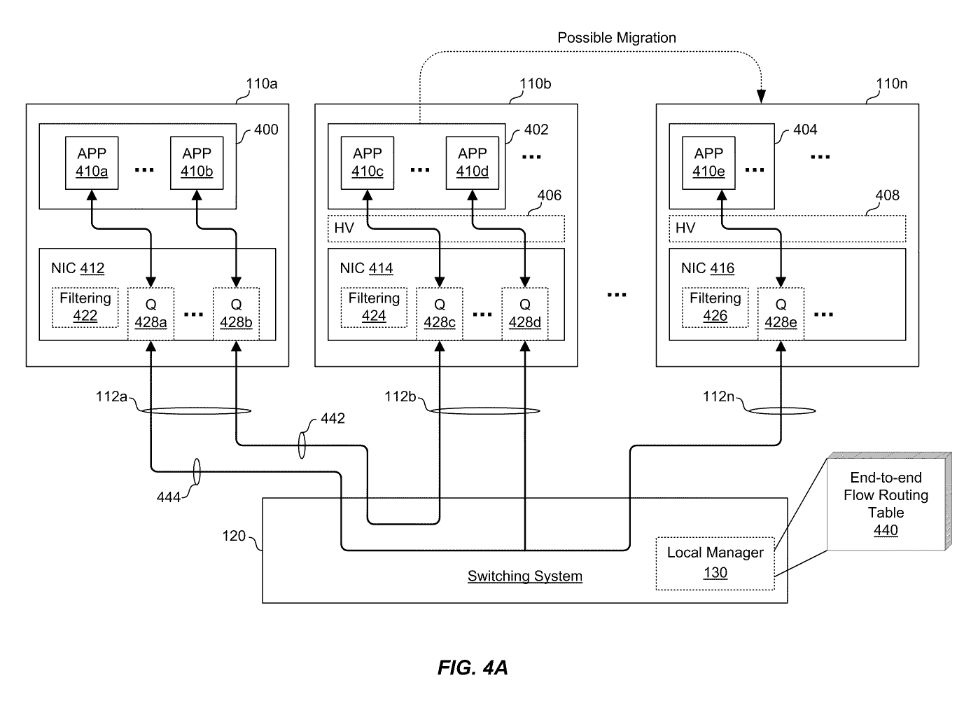

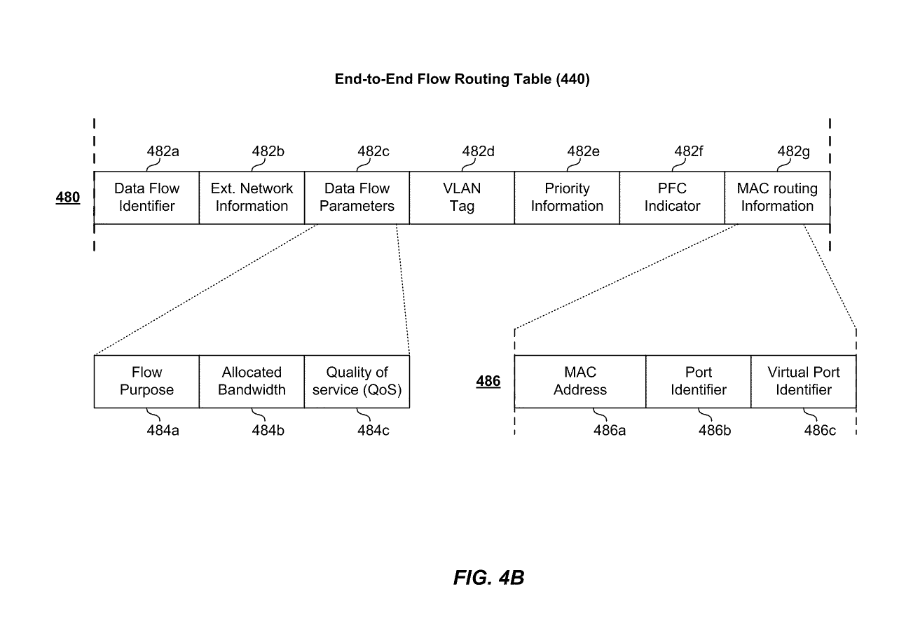

FIG. 4A is a block diagram illustrating an exemplary local networking domain that utilizes end-to-end data flows between network devices via switching devices in the local networking domain, in accordance with an embodiment of the invention. Referring to FIG. 4A, there is shown the local networking domain 100 of FIG. 1, and comprising the plurality of network devices 110a, 110b, . . . , 110n, and the switching system 120, with which the network devices 110a, 110b, . . . , 110n are connected via the network links 112a, 112b, . . . , 112n.

Each of the network devices 110a, 110b, . . . , 110n may be configured to execute a plurality of applications via a single operating system and/or a plurality of virtual machines (VMs), substantially as described with regard to FIGS. 3A and 3B. In this regard, the network device 110a may comprise an operating system 400, in which a plurality of applications 410a-410b may be run and/or executed. The network device 110a may comprise a network interface controller (NIC) 412, which may be similar to the NIC 310, substantially as described with regard to FIG. 3A. Accordingly, the NIC 412 may comprise a filtering block 422 and a plurality of Tx/Rx queues 428a-428b, which may be similar to the filtering block 312 and the plurality of Tx/Rx queues 314a-314n of the NIC 310. The OS 400 may interact directly with the NIC 412 to transmit and/or receive data and/or messages communicated by the plurality of applications 410a-410b for example.

The network device 110b may comprise a plurality of virtual machines (VMs), of which virtual machine (VM) 402 is shown, which is substantially as described with regard to FIG. 3B. For example, the VM 402 may comprise a plurality of applications 410c-410d, and may interact with the NIC 414 via a hypervisor (HV) 406. The network device 110b may comprise a NIC 414, which may be similar to the NIC 412. In this regard, the NIC 414 may also comprise a filtering block 424 and a plurality of Tx/Rx queues 428c-428d. The VM 402 may interact with the NIC 414, via the HV 406 for example, to transmit and/or receive data and/or messages communicated by the plurality of applications 410c-410d, for example. Similarly, the network device 110n may comprise a plurality of virtual machines (VMs), of which virtual machine (VM) 402. The VM 404 may support execution of a plurality of applications, of which the application 410e is shown, and may interact with the NIC 416 via a hypervisor (HV) 408. The network device 110n may comprise a NIC 416, which may also be similar to the NIC 412. The NIC 416 may also comprise a filtering block 426 and a plurality of Tx/Rx queues, of which Tx/Rx queue 428e is shown. The VM 404 may interact with the NIC 416, via the HV 408 for example, to transmit and/or receive data and/or messages communicated by the application 410e for example.

In operation, the local networking domain 100 may be operable to provide guaranteed end-to-end data flows to support applications and/or processes running and/or executing in the network devices 110a, 110b, . . . , 110n, substantially as described with regard to, for example, FIG. 1. In this regard, the local manager 130, which may be executed by the switching system 120 for example, may be operable to establish, configure, and/or manage end-to-end data flows within the local networking domain 100, which may provide and/or maintain guaranteed data transport properties. In this regard, exemplary data transfer properties, which may be guaranteed for end-to-end data flows in the local networking domain 100, may comprise parameters and/or information pertaining to and/or defining allocated bandwidths, quality of service (QoS), service level agreements, security, and/or any combinations thereof. In an exemplary aspect of the invention, the local manager may maintain an end-to-end flow routing table 440, which may be utilized to store information pertaining to configured guaranteed end-to-end data flows in the local networking domain 100. The network devices serviced by guaranteed end-to-end data flow may comprise devices with non-virtualization based architecture, where a single operating system may be running; devices with virtualization based architecture, comprising plurality of a virtual machines (VMs), Single Root I/O Virtualization (SR-IOV), and/or Multi-Root I/O Virtualization (MR-IOV); and/or any combinations thereof. For example, in the local networking domain 100, the network device 110a may be a non-virtualized machine running a single operating system, OS 400, whereas the network devices 110b and 110n may each be configured as virtualized machine, each with a plurality of VMs.

During guaranteed end-to-end data flow servicing in the local networking domain 100, the network devices 110a-110n, or components thereof, such as one or more of the NICs 412, 414, and/or 416; and the switching system 120 may cooperate and/or interact during establishment, configuration, and/or management of guaranteed end-to-end data flows. For example, each of the NICs 412, 414, and/or 416 may be operable to configure and/or preserve networking resources and/or parameters therefor, which may be necessary for supporting each end-to-end data flow. In this regard, networking resources may comprise Tx/Rx queues, MAC/VLAN filtering, and/or bandwidth allocation and/or limiters. The NICs 412, 414, and/or 416 may also be configured to support unicast, multicast, and/or broadcast communications, to provide end-to-end data flows. The networking resources may be determined based on, for example, data communication properties determined via, for example, the host subsystem 202 in each network device. Each of the NICs 412, 414, and/or 416 may be operable to determine how and/or which of the Tx/Rx queues are exposed to and/or associated with specific applications running and/or executing in the corresponding OS or VM(s). For example, the NIC 412 may configure Tx/Rx queue 428a to associate it with application 410a, and/or may configure Tx/Rx queue 428b to associate it with application 410b.

The switching system 120 may perform necessary central control and/or configuration related operations. In this regard, the location manager 130 may be operable to determine the configuration parameters for each device and/or entity which may be traversed in guaranteed end-to-end data flows paths, may prioritize traffic during internal and/or external switching, and may participate in routing at least some of the data and/or messages communicated during end-to-end data flows. Furthermore, in an exemplary embodiment of the invention, a dedicated management interface may be implemented and/or utilized by the switching system 120, and each of the network devices 110a, 110b, . . . , 110n, to setup and control the guaranteed end-to-end data flows. Interactions and/or messages pertaining to the dedicated management interface may be communicated between the switching system 120 and the network devices 110a, 110b, . . . , 110n via the network links 112a, 112b, . . . , 112n.

In an exemplary embodiment of the invention, a data flow 442 may be established and/or configured for communicating data and/or messages between application 410b running in OS 400 in the network device 110a and application 410c running in the VM 402 in the network device 410b. In this regard, the data flow 442 may be established, via the local manager 130, between the network device 110a and the network device 110b. In this regard, the local device 110a may initially determine required data transport properties for the data flow 442. The determination of the data transport properties may be based on, and/or dictated by, user input and/or output, which may be provided and/or obtained via the I/O subsystem 210. Once the data transport requirements are determined, the network device 110a may communicate these parameters to the local manager 130, may then configure other devices and/or entities traversed during data communication via the data flow 442. In this regard, the local manager 130 may configure the switching system 120 and/or the network devices 110a and 110b. Configuring the data flow 442 may comprise, for example, configuring and/or modifying the filtering blocks 422 and 424 to ensure that data packets transmitted and/or received via the data flow 442 are properly filtered and/or routed within the network devices 110a and 110b. For example, the filtering blocks 422 and 424 may filter received data packets based on MAC and/or VLAN related information.

Configuring the data flow 442 may also comprise creating and/or assigning dedicated Tx/Rx queues that are utilized by the corresponding applications 410b and 410c in the network devices 110a and 110b, respectively. In this regard, the queue 428b in the NIC 412 may be used for data and/or messages received and/or transmitted by application 410b, and the queue 428c in the NIC 414 may be used for data and/or messages received and/or transmitted by application 410c. The data flow 444, which may enable communication of data and/or messages, via the switching system 120 for example, among the application 410a running on the OS 400 in the network device 110a, the application 410d running in the VM 402 in the network device 110b, and the application 410e running in VM 404 in the network device 110n, may also be established and/or configured in a substantially similar manner.

In various embodiments of the invention, the Data Center Bridging (DCB) protocol may be utilized to provide guarantee end-to-end data flow servicing in the local networking domain 100. In this regard, because DCB is a per-hop protocol, the servicing of end-to-end data flows in the local networking domain 100, may incorporate and/or be coordinated using DCB on per-hop basis. The servicing of the end-to-end flows may be managed and/or configured by the local manager 130. For example, the DCB protocol, and/or messages may be utilized to request, negotiate, and/or configure each physical NIC port, for example, in the network devices 110a, 110b, . . . , 110n. The end-to-end data flows of any given DCB wire priority may be required, for example, to conform in total to the DCB “contract” for that priority. In other words, the total bandwidth of all end-to-end data flows must be equal to or less than the overall DCB bandwidth.

In various embodiments of the invention, existing guaranteed end-to-end data flows may be maintained during migration operations in the local networking domain 100. In this regard, virtualization of various devices in the local networking domain 100 may enable migration of workloads, for example, virtual machines, and/or applications or processes, between physical machines, using, for example, some for of connectivity between these physical devices in the local networking domain 100. For example, the local networking VM 402 may be migrated from the network device 100b to the network device 100n, using the devices' connectivity via the switching system 120. Accordingly, the local networking domain 100 may be configured to maintain existing guaranteed “contracts” serviced by the VM 402 after migration to the network device 110n. In this regard, properties of the data flow 442, for example, may be maintained during and/or after migration of the VM 402 to the network device 110n. This may comprise maintaining parameters of the data flow 442 such as quality of service (QoS), bandwidth, security, which may comprise ACL and/or authentication related information and/or configuration, and/or any existing service level agreements (SLAs). In addition, routing and/or forwarding of related parameters in the local networking domain 100 may be modified and/or adjusted to ensure seamless connectivity by applications serviced in the VM 402 after the migration. The parameters may be stored and/or maintained via the end-to-end flow routing table 440. Furthermore, all resources utilized on the new path of the existing end-to-end data flow may be configured to ensure that the guaranteed properties of the existing end-to-end data flows are maintained.

Various procedures may be performed, via one or more of the network devices 110a, 110b, . . . , 110n in the local networking domain 100, to ensure continued support of existing end-to-end data flow servicing during and/or after any migrations. For example, migration related events may be synchronized with data communication via corresponding end-to-end data flows, and/or with operations in devices that may be affected during the migration to ensure seamless and/or smooth migration. In this regard, a planning tool may be implemented, via the local manager 130 for example, to support seamless migrations during operations in the local networking domain 110, including end-to-end data flow servicing operations. The planning tool may initially perform a pre-inspection procedure, to validate the migration, and/or to ensure that target device(s) are capable of supporting the migrated entities (e.g. VM or application), and/or that the target devices are capable of supporting the guaranteed properties of affected end-to-end data flow(s). In this regard, the planning tool may analyze the workload and/or resources of the target devices, and/or may be operable to detect mismatches and/or report any errors based thereon. Some flexibility and/or adaptation in reconfiguring the original guaranteed properties of existing end-to-end data flows may be allowed. In this regard, the local manager 130 may determine, based on preconfigured information and/or user input for example, permissible modifications to at least some of the originally guaranteed properties, such as QoS or bandwidth, in instances where the original “contract” may not be supportable after the migration

In various embodiments of the invention, the Open Virtualization Format (OVF) protocol, which is a Distributed Management Task Force (DMTF) based protocol, may be utilized in the local networking domain 100, for example, to ensure continued and/or seamless support of existing end-to-end data flow servicing in instances where virtualization and migration are used and/or performed in the local networking domain 100. In OVF based migrations, metadata may be utilized to facilitate migration of virtual machines, and/or applications running on operating systems, between physical machines. Accordingly, a metadata which describes a migrating virtual machine (VM), and/or any entity or application which may needs be moved dynamically, may be modified (the metadata) to also describe related end-to-end data flows that may service, or be serviced by, the migrating entity to ensure that continued and/or undisturbed data flow servicing in the local networking domain 100.

FIG. 4B is a block diagram that illustrates exemplary structures of elements in an end-to-end routing table that may be utilized in a local networking domain to support guaranteed end-to-end data flows, in accordance with an embodiment of the invention. Referring to FIG. 4B, there is shown there is shown the end-to-end flow routing table 440 of FIG. 4A, which may be utilized in to support configuring, maintaining, and/or managing guaranteed end-to-end data flows in the local networking domain 100.

The end-to-end flow routing table 440 may comprise a plurality of data flow profile elements 480, each of which may correspond to a guaranteed end-to-end data flow in the local networking domain 100. The data flow profile element 480 may comprise, for example, a plurality of fields that may be set and/or used to identify an internal data flow in the local networking domain 100, and/or to perform necessary configuration and/or management operations. In this regard, the data flow profile element 480 may comprise, for example, a data flow identifier (ID) field 482a, an external networking information field 482b, data flow parameters field 482c, a virtual local area network (VLAN) tag field 482d, a priority information field 482e, a priority flow control (PFC) indicator 482f, and a MAC routing information field 482g. The data flow parameters field 482c may comprise a plurality of sub-fields which may be set and/or used for configuring and/or determining specific data transport related parameters. In this regard, the data flow parameters field 482c may comprise a flow purpose information field 484a, an allocated bandwidth field 484b, and a quality of service field 484c. In an exemplary embodiment of the invention, the MAC routing information field 482g may comprise a plurality of MAC routing information elements 486. In this regard, each MAC routing information element 486 may comprise, for example, a MAC address field 486a, a port identifier field 486b, and a virtual port identifier field 486c.

In operation, the end-to-end flow routing table 440 may be constructed and/or generated, via the switching system 120 for example, using a plurality of the data flow profile element 480 during establishment, configuration, use, and/or management of guaranteed end-to-end data flows in the local networking domain 100, between the network devices 110a, 110b, . . . , 110n. For example, when the data flow 444 is established, a new instance of the data flow profile element 480, or an available existing instance, may be populated and/or modified based on, for example, guaranteed data flow parameters and/or information pertaining to devices communicating and/or routing the data and/or messages exchanged via the data flow 444. In this regard, the data flow ID field 482a may be set to unique value that the identifies data flow 444. The values assigned to data flows in the domain 100 may be generated randomly and/or sequentially. The external networking information field 482b may be updated with information necessary for processing at least some of the data flow 444 external to the domain 100, to enable communicating with entities and/or devices accessed via the network 140 for example. In instances where the data flow 444 is wholly internal to the domain 100, the external networking information field 482b may remain unset, and/or may be set to predefined value indicating absence of external connectivity. The flow parameters field 482c may be set to reflect guaranteed data communication related properties. In this regard, the flow purpose information field 484a, the allocated bandwidth field 484b, and/or the quality of service field 484c may be set based on values determined by the network devices 110a, 110b, and/or 110n; or based on negotiated and/or reconfigured values by the local manager 130.

The VLAN tag field 482d may be set to a determined VLAN tag that uniquely identifies data packets communicated through the data flow 444. In this regard, the VLAN tag may be utilized by the filtering blocks 422, 424, and/or 426 in the NICs 412, 414, and/or 416 to forward data messages between applications and assigned Tx/Rx queues in the corresponding NICs. The priority information field 482e may be configured to indicate the priority of each data flow compared to other data flows in the domain 100. In this regard, data and/or messages corresponding to data flows with higher priority indicator values may be routed and/or forwarded first. The PFC indicator 482f may be configured to indicate whether (or not) priority flow control (PFC) support for the corresponding data flow is enabled. The MAC routing information field 482g may be configured with MAC related routing information corresponding to the devices that are used and/or traversed in the data flow 444. In this regard, the MAC routing information field 482g may be configured to comprise 3 instances of the MAC routing information element 486, corresponding to the network devices 110a, 110b, and 110n. For example, each of the 3 instances of the MAC routing information element 486 may be configured to store in the MAC address field 486a the MAC address of the corresponding network device; to store in the port identifier field 486b the port number/identifier corresponding to the Tx/Rx queue used in the corresponding NIC to receive data or messages via the data flow 444; and/or to store in the virtual port identifier field 486c the virtual port identifier parameter corresponding to the virtual port (if the network device uses virtualization) corresponding to the data flow 444.

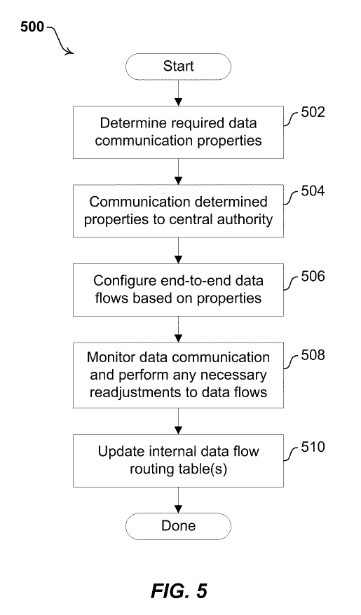

FIG. 5 is a flow chart that illustrates exemplary steps for configuring and maintaining guaranteed end-to-end data flows in a local networking domain, in accordance with an embodiment of the invention. Referring to FIG. 5, there is shown a flow chart 500 comprising a plurality of exemplary steps that may be performed in a local networking domain to enable configuring, maintaining, and/or using guaranteed end-to-end data flows.

In step 502, required data communication properties and/or parameters may be determined. For example, one or more of the network devices 110a, 110b, . . . , 110n may determine data communication properties necessary for data and/or message communicated during execution of processes and/or applications in these network devices. In step 504, the determined properties may be communicated to a central authority. For example, the network devices 110a, 110b, . . . , 110n may communicate the determined data communication properties to the switching system 120. In step 506, guaranteed end-to-end data flows may be configured based on the determined data communication properties. In this regard, the switching system 120 may configure, via the local manager 130 for example, the data flows 442 and/or 444 in the local networking domain 100. In step 508, data communication via the configured end-to-end data flows may be monitored, and in instances where any change in conditions and/or requirements are detected, for example during migration, necessary readjustments and/or modifications to the guaranteed data flows may be performed, via the local manager 130, for example. In step 510, internal data flow routing table(s) may be updated. For example, the end-to-end flow routing table 440 may be generated and/or updated in the local networking domain 100 to store and/or adjust, for example, instances of the data flow profile element 480 corresponding to the data flows 442 and/or 444.

Various embodiments of the invention may comprise a method and system for seamless consummation of an electronic transaction based on location related data. The local manager 130 may configure one or more of the network devices 110a, 110b, . . . , 110n and/or one or more of the switching devices 122a-122m in the local networking domain 100 to establish end-to-end data flows with guaranteed communication related properties and/or parameters. The local manager 130 may be implemented and/or run in, at least in part, the one or more switching devices 122a-122m. Data flow routing tables maybe maintained and/or updated based on usage of the existing guaranteed end-to-end data flows. The network devices 110a, 110b, . . . , 110n may utilize the guaranteed end-to-end data flows to service applications that may be running on the network devices 110a, 110b, . . . , 110n, such as applications 410a, . . . , 410e. For example, the guaranteed end-to-end data flows may be used for communicating data and/or messages transmitted and/or received by applications running in the network devices 110a, 110b, . . . , 110n. The network device 200, which may correspond to one or more of the network devices 110a, 110b, . . . , 110n, may be operable to determine, via the host processor 204 and/or the networking subsystem 220 for example, data flow requirements for each application running in the network device 200. The data flow requirements may comprise bandwidth, quality of service (QoS), security, and/or service level agreement (SLA) related parameters. The determined data flow requirements may be communicated to one or more of the switching devices 122a-122m, which may, in conjunction with the local manager 130, establish, configure, and/or manage guaranteed end-to-end data flows in the local networking domain 100, based on, at least in part, the received data flow requirements. The network devices 110a, 110b, . . . , 110n may allocate, during configuration of end-to-end data flows, networking resources to guarantee the end-to-end data flow for each application running in each of the network devices 110a, 110b, . . . , 110n.

One or more of the switching devices 122a-122m may maintain, in conjunction with the local manager 130, the end-to-end flow routing table 440, which may comprise a plurality of the data flow profile element 480, each of which may be used for storing information corresponding to a guaranteed end-to-end data flow established and/or supported in the local networking domain 100. To facilitate maintenance of routing information, each of the end-to-end data flows may be assigned a unique identifier for routing and/or switching operations in the local networking domain 100, which may be stored in the corresponding data flow profile element 480. Furthermore, each end-to-end data flow may also be assigned a unique virtual local area network (VLAN) tag, which may be used, in the network devices 110a, 110b, . . . , 110n for example, for filtering of, in the NIC 310 for example, data received and/or transmitted during use of guaranteed end-to-end data flows. In instances where the one or more of the network devices 110a, 110b, . . . , 110n are implemented as virtual platforms, guaranteed end-to-end data flow servicing may be supported using virtualization related entities in the network devices. Furthermore, the guaranteed end-to-end data flow servicing may be maintained and/or continued when serviced applications, and/or virtual machines in which the application may be run or executed, may be migrated between different physical platforms of the network devices 110a, 110b, . . . , 110n.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for guaranteed end-to-end data flows in a local networking domain.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a switching device that provides switching services in a local networking domain that comprises a plurality of network devices:
receiving from at least a first network device of said plurality of network devices, data flow requirements for communicating data for each of a plurality of applications running on said first network device; and
configuring, by said switching device in conjunction with a local manager, said first network device and/or one or more remaining network devices from said plurality of network devices to maintain guaranteed end-to-end data flows for each of said plurality of applications based on said received data flow requirements.

2. The method according to claim 1, wherein said switching device comprises a blade switch or a top-of-rack (ToR) switch.

3. The method according to claim 1, wherein said data flow requirements comprise bandwidth, quality of service (QoS), security, and/or service level agreement (SLA) based parameters.

4. The method according to claim 1, wherein said local manager runs on said switching device.

5. The method according to claim 1, comprising maintaining, by said switching device in conjunction with said local manager, a routing table for storing information corresponding to said end-to-end data flows.

6. The method according to claim 1, comprising assigning, by said switching device in conjunction with said local manager, each of said guaranteed end-to-end data flows a unique identifier for routing and/or switching operations in said local networking domain.

7. The method according to claim 1, comprising assigning, by said switching device in conjunction with said local manager, each of said guaranteed end-to-end data flows a unique virtual local area network (VLAN) tag for routing and/or switching data in said first network device and/or in said one or more other network devices.

8. The method according to claim 1, comprising maintaining, by said switching device in conjunction with said local manager, servicing of said guaranteed end-to-end data flows during migration operations in said local networking domain.

9. The method according to claim 1, wherein said first network device and/or at least a portion of said one or more other network devices is operable to determine said data flow requirements for each application running in said network device.

10. The method according to claim 1, wherein said first network device and/or at least a portion of said one or more other network devices is operable to allocate networking resources to guarantee said end-to-end data flow for each of said plurality of applications.

11. A system for communication, the system comprising:
one or more circuits and/or processors for use in a switching device that provides switching services in a local networking domain that comprises a plurality of network devices, said one or more circuits and/or processors are operable to:
receive from at least a first network device of said plurality of network devices, data flow requirements for communicating data for each of a plurality of applications running on said first network device; and
configure, by said switching device in conjunction with a local manager, said first network device and/or one or more remaining network devices from said plurality of network devices to maintain guaranteed end-to-end data flows for each of said plurality of applications based on said received data flow requirements.

12. The system according to claim 11, wherein said switching device comprises a blade switch or a top-of-rack (ToR) switch.

13. The system according to claim 11, wherein said data flow requirements comprise bandwidth, quality of service (QoS), security, and/or service level agreement (SLA) based parameters.

14. The system according to claim 11, wherein said local manager runs on said switching device.

15. The system according to claim 11, wherein said one or more circuits and/or processors are operable to maintain, by said switching device in conjunction with said local manager, a routing table for storing information corresponding to said end-to-end data flows.

16. The system according to claim 11, wherein said one or more circuits and/or processors are operable to assign, by said switching device in conjunction with said local manager, each of said guaranteed end-to-end data flows a unique identifier for routing and/or switching operations in said local networking domain.

17. The system according to claim 11, wherein said one or more circuits and/or processors are operable to assign, by said switching device in conjunction with said local manager, each of said guaranteed end-to-end data flows a unique virtual local area network (VLAN) tag for routing and/or switching data in said first network device and/or in said one or more other network devices.

18. The system according to claim 11, wherein said one or more circuits and/or processors are operable to maintain, by said switching device in conjunction with said local manager, servicing of said guaranteed end-to-end data flows during migration operations in said local networking domain.

19. The system according to claim 11, wherein said first network device and/or at least a portion of said one or more other network devices is operable to determine said data flow requirements for each application running in said network device.

20. The system according to claim 11, wherein said first network device and/or at least a portion of said one or more other network devices is operable to allocate networking resources to guarantee said end-to-end data flow for each of said plurality of applications.
